(19) United States
(12) Patent Application Publication
(10) Pub. No.: US 2018/0338430 A1
(43) Pub. Date: Nov. 29, 2018

(54) AEROPONIC IRRIGATION SYSTEM

(71) Applicant: GnomeWorks Greenhouse Inc., Toronto (CA)

(72) Inventors: Anton N. COBZEV, Toronto (CA); Shawn K. PAHWA, Toronto (CA)

(21) Appl. No.: 15/990,879

(22) Filed: May 29, 2018

Related U.S. Application Data
(60) Provisional application No. 62/511,384, filed on May 26, 2017.

(51) Int. Cl. A01G 9/24; A01G 31/02

(52) U.S. Cl. CPC A01G 9/247; A01G 29/00; A01G 31/02

(57) ABSTRACT

A microponic irrigation system is formed using a plurality a grow tubes, a pressure manifold, and a drainage manifold. Each of the plurality of grow tubes defines a grow chamber within the interior of the grow tube and is provided with at least one cradle assembly to support of a plant disposed with its roots suspended in air within the grow chamber. The pressure manifold fluidly couples a reservoir to each of the plurality of grow tubes and delivers nutrient solution housed in the reservoir to the plurality of grow tubes under pressure. The pressurized nutrient solution delivered to the grow tubes is misted into each grow chamber to be absorbed into the roots of each rooted clone supported in the grow tube. The drainage manifold collects unabsorbed nutrient solution from each of the plurality of grow tubes and circulates the unabsorbed nutrient solution back to the reservoir.

### CROSS-REFERENCE TO RELATED APPLICATIONS

This application claims all right and benefit of U.S. provisional application Ser. No. 62/511,384, filed May 26, 2017, the entire contents of which are herein incorporated by reference.

### TECHNICAL FIELD

The present invention relates to the field of agriculture, and more specifically, the use of aeroponic technologies for large-scale commercial production.

### BACKGROUND

A multitude of technologies and different growing techniques are used for the cultivation of both small and large plants. When one considers traditional agriculture, an image which often comes to mind is row upon row of field crops. The manner in which these plants are grown is what is referred to as “geoponics”, that is, the cultivation of plants in some form of solid-state growing media. These substrates can include, but are not limited to soil, peat-based soilless mixes, and alternative materials such as coconut fiber. Geoponic methods generally provide plants with everything they need to survive. However, there are some drawbacks to these traditional methods.

First, whether cultivation occurs in fields or pots, feeding usually consists of pouring water around the base of the plant stem. This results in at least some of the water being absorbed into the ground and draining to waste rather than being absorbed by the plant. Second, these substrates often provide ideal conditions for unwanted pests and disease, which often require the use of chemical sprays to treat.

Water-based systems called “hydroponics” offer numerous benefits over geoponic-based growing methods and come in several different types including ebb and flow, nutrient film technique (NFT), and deep-water culture (DWC). These systems may work in different ways, but generally may involve roots that are partially or completely submerged in an oxygenated nutrient solution. This allows the roots to absorb nutrients directly instead of through a physical substrate like soil, thereby resulting in plants which generally grow faster and larger. Additionally, these systems are usually close-looped, meaning excess runoff is captured and returned to the reservoir.

However, despite their numerous benefits, hydroponic systems have their limitations as well. As feeding involves the root zone being flooded with a fertilizer solution, complications can arise if this solution does not contain an adequate amount of dissolved oxygen. As the leaves of a plant require carbon dioxide for photosynthesis, the roots require oxygen for osmosis. Without sufficient oxygenation, roots become water-logged which can result in root rot, drastically affecting the size and quality of the crop. It is often impossible to recover from such situations. In addition, each individual hydroponic unit usually requires a dedicated reservoir. If more units are added to the system, these additional reservoirs also have to be monitored and maintained, which requires considerable time and resources. Although these systems utilize water more efficiently than traditional geoponics, there are other alternatives which are can offer additional advantages over hydroponics.

### SUMMARY

Configurations of a microponic irrigation system as described herein have been adapted to promote the health and integrity of root hair cells in plants, and to do so on a commercial scale throughout the plant's life cycle. According to the disclosed embodiments, nutrient solution stored in a reservoir is pumped into a tank where it is pressurized. It is then sent down a manifold which runs the length of the cultivation area. The manifold feeds the pressurized solution through to a series of horizontal tubes which provide a support structure for the plants. The solution is then passed through nozzles which produce a fine mist wherein the beads of solution measure approximately 50 μm as an example. This small size results in a fine mist which moistens the root mass without damaging the delicate root hair cells. Any excess runoff flows via gravity through a particulate filter and is returned to the nutrient reservoir.

According to further aspects of the disclosed invention, a computer control system featuring software controllers works in conjunction with embodiments of the microponic irrigation system to monitor and automate frequency and duration of misting. Any detected anomalies are recorded and corresponding notifications are sent to the operator. Adjustments to the system can be made using either a physical graphic user interface or through a network using a mobile device, or through suitable alternative devices or embodiments that provide equivalent functionality.

### BRIEF DESCRIPTION OF THE DRAWINGS

Various aspects and embodiments of the invention are illustrated in the accompanying drawings, which are meant to be exemplary and not limiting, and in which like references are intended to refer to like or corresponding parts.

FIG. 1 shows an operational flow chart illustrating a microponic irrigation system according to the described embodiments.

FIG. 2 shows an example embodiment of a microponic irrigation system.

FIG. 3 shows a close-up of reservoir systems included in the embodiment shown in FIG. 2.

FIG. 4 shows a close-up of manifolds and pressurized lines, as well as part of the a grow tube support structure included in the embodiment shown in FIG. 2.

FIG. 5 shows another part of the grow tube support structure, as well as example dimensions of horizontal grow tubes included in the embodiment shown in FIG. 2.

FIG. 6 shows a cross-section of a first example configuration of a grow tube that may be used for smaller plants during the vegetative stage of growth.

FIG. 7 shows a cross-section of a second example configuration of a grow tube that may be used for mature plants during the flowering period.

FIG. 8 shows a deconstruction of a cradle assembly included in the grow tube of FIG. 6 or FIG. 7.

FIG. 9 shows an internal view of a grow chamber according to the second example configuration of a grow tube shown in FIG. 7, identifying the cradle tabs and misting nozzles.

FIG. 10 shows an internal view of a horizontal tube according to the first example configuration of a grow tube shown in FIG. 7, with plants visible in the cradle assemblies.

### DETAILED DESCRIPTION

Aeroponic technology has been around for several decades but has not seen widespread use as these systems are often more complex. One principle of aeroponic systems that is similar to water-based systems is that nutrient solution is fed directly to the root zone resulting in vigorous growth. However, these systems differ in the manner in which they achieve this. Instead of saturating the root zone, e.g., by immersion in a liquid solution, plants grown in aeroponic systems have their root structures suspended in an enclosed environment, wherein nutrient solution is misted onto the roots. Aeroponic systems thereby provide plant roots simultaneously with direct access to both nutrient solution and oxygen, which reduces potential complications such as root rot as described herein. Additionally, aeroponic systems require only a fraction of the volume of water used in hydroponic systems.

Despite the fact that aeroponics has been around for some time, the technology has not generally been adapted for commercial production. Many aeroponic systems claim to be scalable, which is often not the case. For example, similar to most hydroponic systems, many designs call for modular units each containing their own water pumps, air pumps, and reservoirs. Although one may increase their production capacity by adding additional units, this would require a considerable amount of resources and maintenance. This is impractical for commercial scale production.

Furthermore, the vast majority of aeroponic systems do not take into account the finer aspects of root health and fail to tap the true potential of aeroponic technology. These systems often feature nozzles that have been designed to spray relatively droplets of water that can damage the sensitive portions of the root mass, particularly root hair cells. Root hair cells form on the epidermis of roots and play a primary role in the osmosis process. These cells include a fine extension, or “hair”, which results in a relatively large surface area, allowing molecules to pass with greater ease through the semi-permeable membrane. Optimal root health would include the proliferation of these cells.

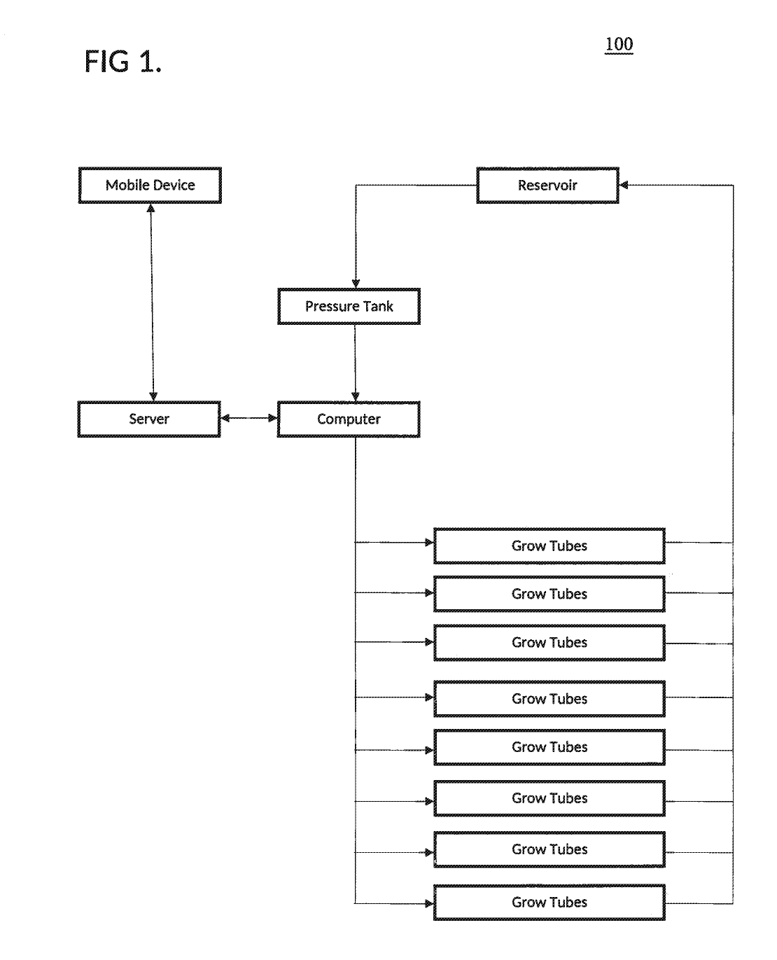

Referring initially to FIG. 1, the flow chart depicted therein schematically illustrates operation of an embodiment of a microponic irrigation system 100 according to the invention. Current aeroponic systems of today incorporate dedicated reservoirs and pumps for each growing unit. Conversely, microponic irrigation system 100 shown in FIG. 1 makes use of a single reservoir and tank to pressurize the nutrient solution which is subsequently misted in precise, incremental amounts. As a result, in some cases, one reservoir can support an entire bank of grow tubes, thereby reducing input costs such as nutrients and labour.

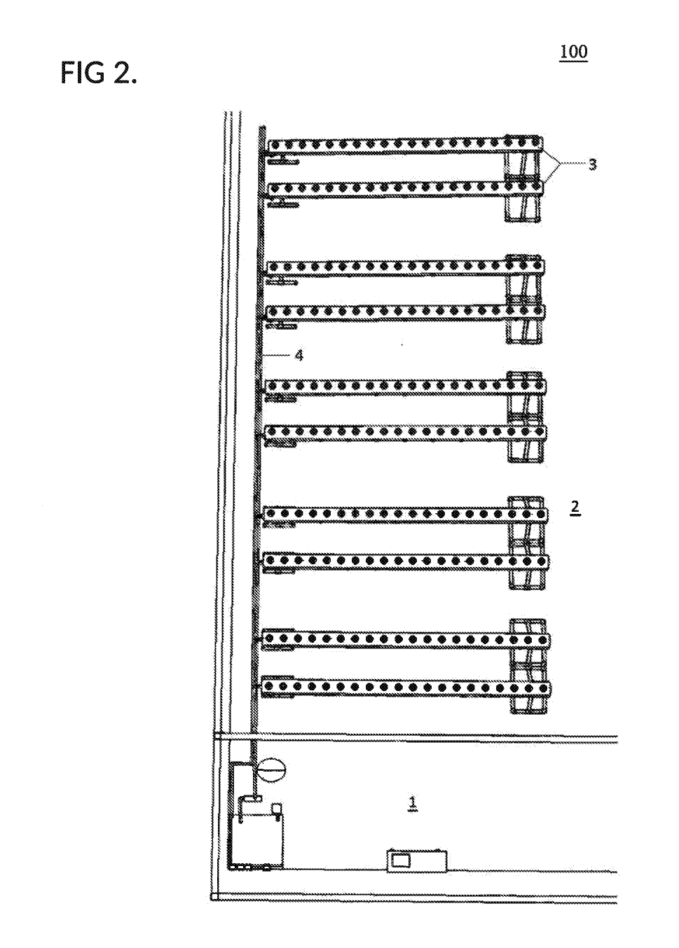

FIG. 2 depicts an example embodiment of microponic irrigation system 100 according to the disclosure. In some cases, as shown, microponic irrigation system 100 can include reservoir area 1, cultivation area 2, a plurality of horizontal tubes 3, and manifolds 4, which in combination allow solution to flow between reservoir area 1 and cultivation area 2. Manifolds 4 can be connected in some cases to each of the horizontal tubes 3, which may be arranged in pairs, two feet apart center to center. In some cases, additional pairs of tubes can be added to the system by extending the manifolds 4 by a distance of 6 feet or so. This will result in a 2-foot aisle between pairs of horizontal tubes 3, and an additional 2-feet per tube 3 for sufficient canopy space.

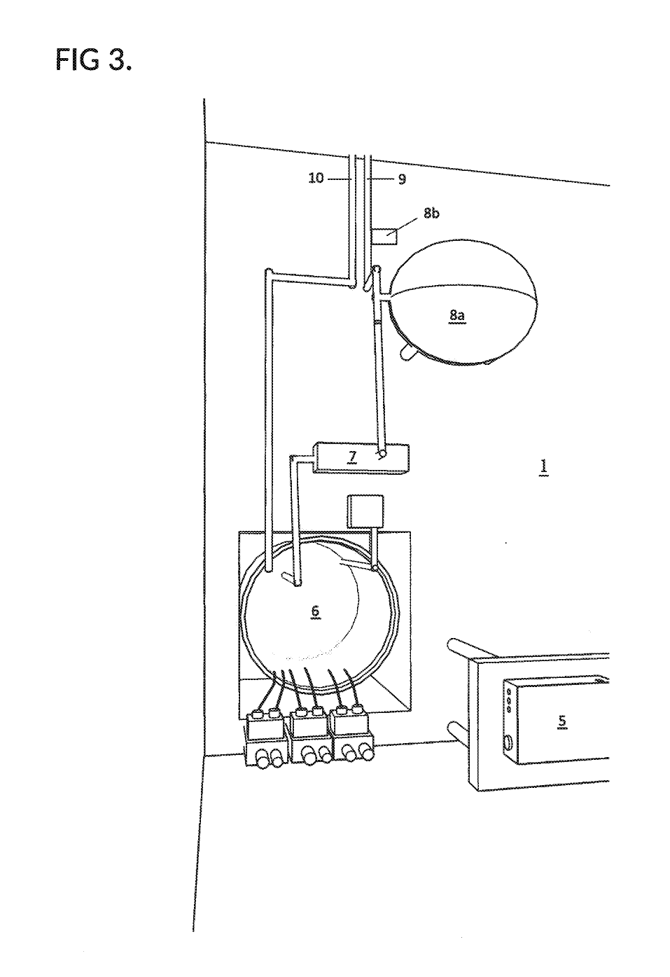

The reservoir area 1 is shown in close up in FIG. 3. A computer control system 5 may include a graphic user interface (GUI) which an operator can use to adjust and monitor the various settings of microponic irrigation system 100. The computer board module receives data from the GUI and saves it to memory. Based on interval parameters outlined by the user, the computer board module activates a relay that is connected to a solenoid valve. Based on the desired duration set by the user, the computer deactivates the relay, closing the solenoid valve and ending the spray. Through the GUI, users can adjust the number of horizontal tubes 3 that are operatively connected to the system 100, and modify the frequency and duration of feedings by 15-second and 0.5-second increments, respectively, for example. Default settings may include a 1-second misting every 2-minutes for the present embodiment. In addition, users can also input the desired pressure range of the system 100, which defaults to upper and lower limits of 80 and 50 psi, respectively, for example.

To start, a reservoir 6 may be filled with a nutrient solution. A water pump 7 moves the nutrient solution to a pressure tank 8a, wherein the solution is pressurized. In an example 20-gallon tank, a pressure reduction from 80 to 50 psi would equate to a drawdown factor of 6 gallons. For example, in this embodiment, a water pump 7 rated at 240 gallons per hour could be utilized, with each horizontal tube 3 supported by the system 100 being allocated up to 50 litres of capacity per day in reservoir 6. The pressurized solution is sent to the cultivation area 2 via pressure manifold 9. As feedings occur, pressure within pressure tank 8a and along the pressure manifold 9 begins to decrease. A pressure sensor 8b is utilized to monitor the pressure within the lines and relays this information to computer control system 5. When the monitored pressure falls below the defined range, the computer is configured to respond by activating the water pump 7, re-pressurizing the accumulator tank. Once the upper pressure limit is detected, computer control system 5 is configured to deactivate water pump 7. A drainage manifold 10 configured with a 1-degree gradient, for example, returns any runoff to reservoir area 1. In some embodiments, pressure manifold 9 and drainage manifold 10 may consist of segments of pvc and corresponding 90 degree elbow fittings with an inner diameter (ID) of 0.5″ providing sufficient flow to system 100.

Computer control system 5 can be implemented using different configurations of hardware and/or software components. For example, in some cases, computer control system 5 may comprise one or more general or special purpose processors that are configured to execute instruction(s) or instruction set(s) that may be stored in non-transient memory accessible by the processor(s). Such memory may include any combination(s) of volatile or persistent memory(ies), such as flash, RAM, ROM, hard-drives, solid-state drives, at the like. Such memory(ies) can have stored thereon data or instructions which when executed cause the processor(s) to execute the various actions or functions as described herein.

In some cases, computer control system 5 may also comprise a server or other suitable local or wide area network device so as to communicate with a mobile device. In such cases, the mobile device user may input instructions (for example, through an application or other program installed on the device) that are communicated through the server in order to control system 100.

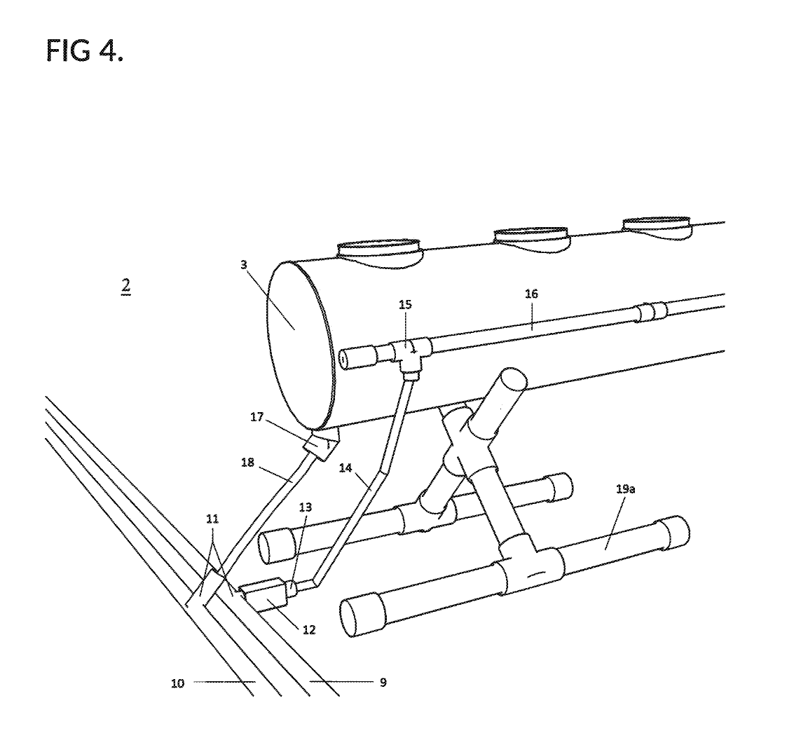

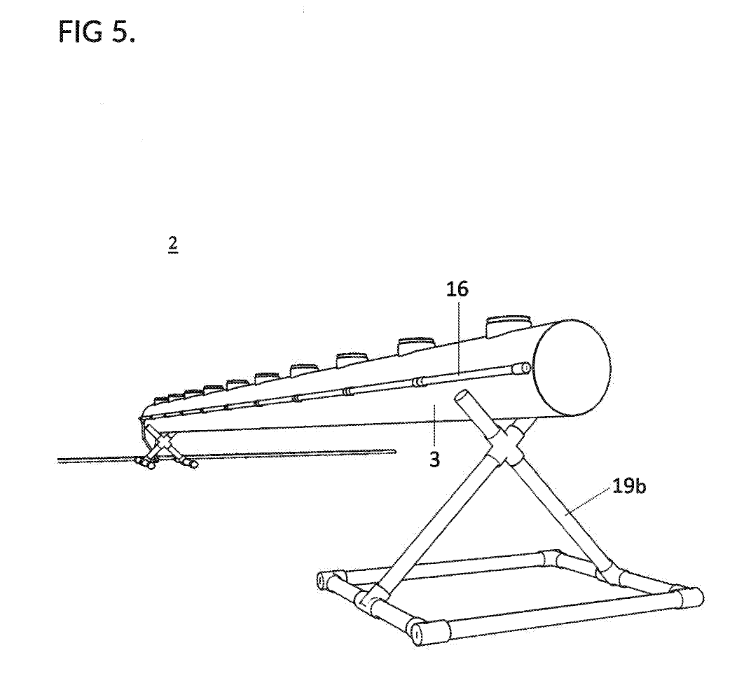

Reference is now made to FIG. 4, which shows a close up of pressure manifold 9 and drainage manifold 10 according to some embodiments. As shown, pressurized nutrient solution flows through pressure manifold 9 to a solenoid valve 12, which can be connected together using a T-fitting 11 composed of pvc with a 0.5″ ID, for example. To the outlet port of solenoid valve 12 is attached a 0.5″ ID union 13, which in turn is attached to a 0.5″ ID pressure hose 14 composed of a food-grade composite measuring approximately 1-foot in length. When solenoid valve 12 is activated by the computer control system 5, solution is fed up to a pressure line 16 running substantially the length of the horizontal grow chamber. Pressure hose 14 and pressure line 16 are connected also using a 0.5″ ID T-fitting 15, for example. A 45-degree drain elbow 17 with a 0.5″ ID channels runoff to drainage manifold 10 via a 0.5″ ID drainage hose 18, returning the runoff to reservoir area 1. Also illustrated in FIG. 5 is a configuration of a support structure 19a, which in an example embodiment consists of 8″, 9″, and 12″ segments of 1.5″ diameter pvc pipe secured together with corresponding X and T-fittings.

Referring now to FIG. 5, there is shown a configuration of a support structure 19b, which can be utilized as an alternative (or in addition) to the support structure 19a shown in FIG. 4. As shown, support structure 19b may be comprised of 6″, 12″, 14″, and 24″ segments of 1.5″ diameter pvc pipe with corresponding 90-degree elbows and VT-fittings. A 10″ diameter horizontal tube 3 or grow chamber is also shown, which measures 20 feet in length, for example. Similar to drainage manifold 10, the horizontal Tube 3 shown in FIG. 5 may incorporate a 1-degree gradient to facilitate drainage. Pressure line 16 may consists of segments of 0.5″ ID pvc, and T-fittings which are spaced approximately 24″ apart. T-fittings situated at either end of pressure line 16 can be spaced 23″ from adjacent T-fittings so as to be contained within horizontal tube 3.

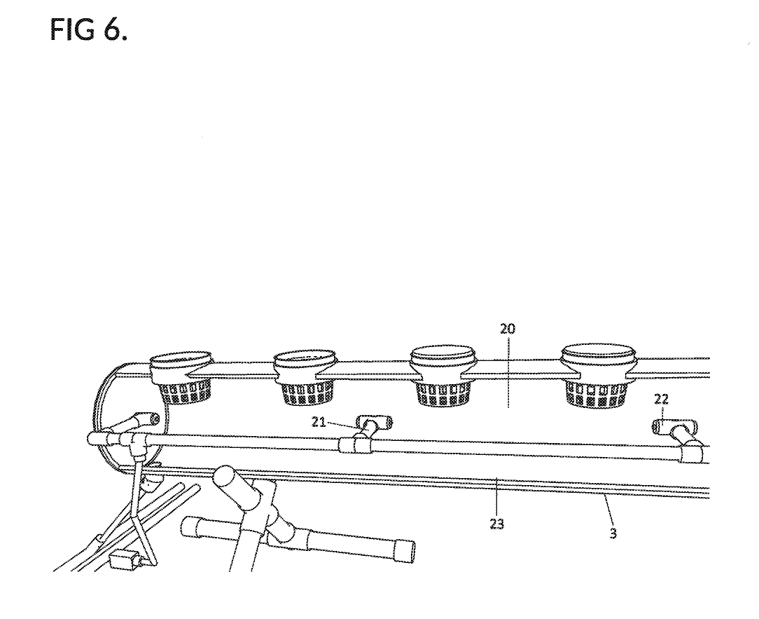

FIG. 6 shows a first configuration (A) of a grow tube. This example configuration can support up to twenty plants to a maximum canopy size of 1 square foot each. Plants are supported along the top of horizontal tube 3 with their roots suspended in rhizosphere or root zone 20. Nutrient solution moves along pressure line 16 to nozzle T-Joints 22 by way of nozzle support extensions 21 measuring, for example, 5.875″ in length. These dimensions will result in nozzle T-Joints 22 being situated generally at the center of horizontal tube 3. After feeding, any excess runoff flows along drainage channel 23 to drain elbow 17.

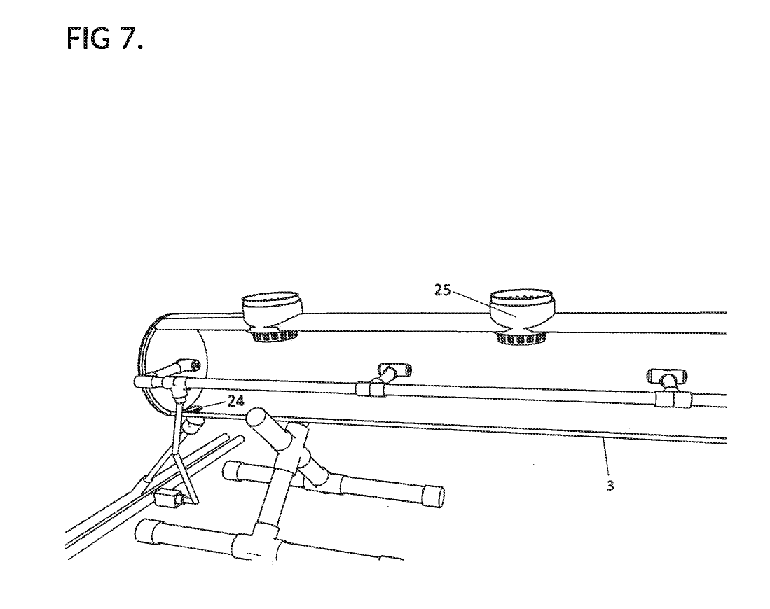

FIG. 7 shows a second configuration (B) of a grow tube. This alternative configuration, which can support up to ten plants to a maximum canopy size of 2 square feet each, may include a particulate filter 24 which covers the drain and a modified version of a cradle assembly 25. While the two configurations shown in FIGS. 6 and 7 may exhibit some similarities as compared to each other, they may differ in at least the spacing of cradle assemblies 25. Systems with configuration A (FIG. 6) may comprise cradle assemblies 25 which are centered 6″ from each end of horizontal tube 3 and spaced one foot apart, center to center, from adjacent cradle assemblies 25. In addition, the figure configuration (A) may feature only one dedicated nozzle per plant. Systems with configuration B (FIG. 7) may comprise cradle assemblies 25 that are centered 12″ from each end of horizontal tube 3 and spaced two feet apart, center to center, from adjacent cradle assemblies 25. Moreover, there may be two dedicated nozzles per plant the second configuration (B), which can mist a volume of water that supports a larger root mass than could a single nozzle.

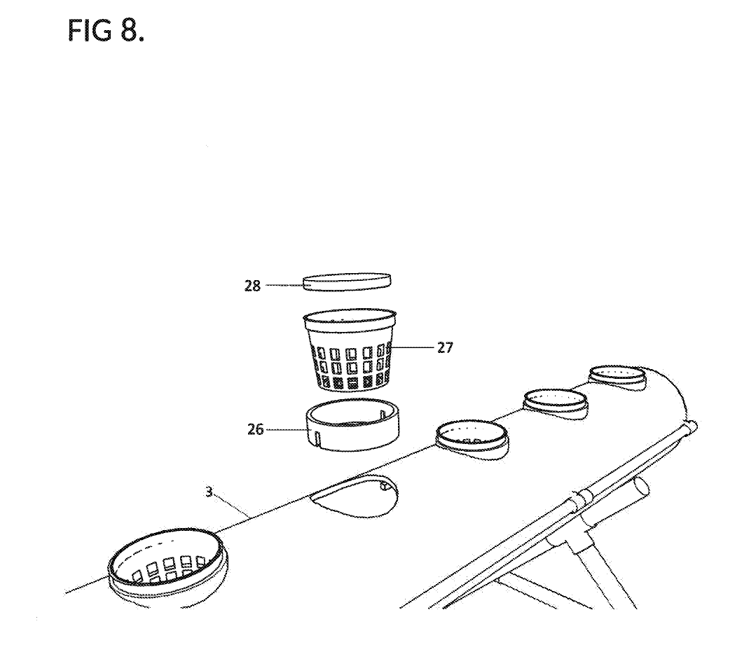

Referring now to FIG. 8, there is illustrated a deconstruction of a cradle assembly 25 comprising a sleeve 26, net pot 27, and rubber-foam insert 28. Sleeve 26 may comprise a segment of, e.g., 5″ diameter pvc pipe which slides into a port situated along the top of horizontal tube 3. A rooted clone is secured to foam-rubber insert 28, which can be composed of composite materials such as neoprene. Foam-rubber insert 28 may then subsequently be placed in a corresponding net pot 27, which may then be lowered into sleeve 26 of cradle assembly 25. Foam-rubber insert 28 and net pot 27 may each have 5″ diameters in some embodiments. This configuration of cradle assembly 25 may in some cases facilitate deconstruction for cleaning and maintenance or other purposes.

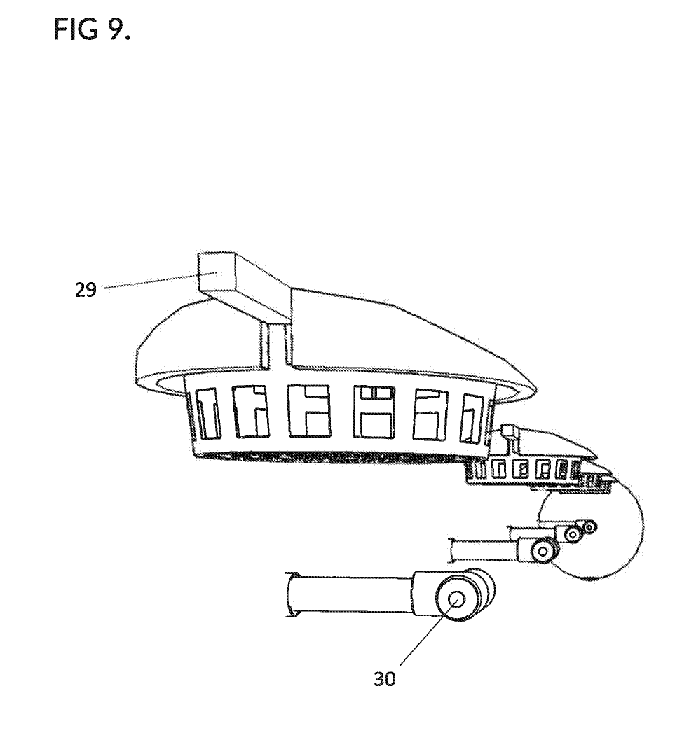

The illustration seen in FIG. 9 provides additional details on the underside of cradle assembly 25 as it sits in horizontal tube 3. As shown, cradle tabs 29 with a ⅜″ width, for example, slide through 1″ deep channels on sleeve 26, thereby securing it in place. Sleeves 26 in the second configuration (B) shown in FIG. 7 can measure 2.5″, whereas sleeves 26 in the first configuration (A) shown in FIG. 6 can measure 1.5″ in length, allowing cradle assemblies 26 in the second configuration (B) to sit higher in the growing chamber relative to the first configuration (A). The additional space realized in the in the second configuration (B) provides roots with additional room to grow as the plants mature.

In the example embodiments of a microponic irrigation system 100 described herein, nozzles 30 may flow at a rate of approximately 0.84 g/h, and produce micro-droplets which measure up to 50 μm in size. Additionally, nozzles 30 may produce a mist with a spread of 80 degrees or so to result in complete or substantially complete coverage of plant roots. Nozzles 30 can be secured to nozzle T-Joints 22 using 0.5″ to 0.25″ reducers. This configuration does not necessarily spray roots with droplets of nutrient solution, but instead may moisten them with a fine mist. This process helps to maintain the integrity of root hair cells. These cells are regarded as important parts of the root system when it comes to the process of osmosis. That is, the thin walls and large surface areas of these cells allow nutrient molecules to pass with greater ease through the semi-permeable membrane. As a result, larger quantities of oxygen and nutrients can be absorbed by a plant which leads to fast, vigorous growth.

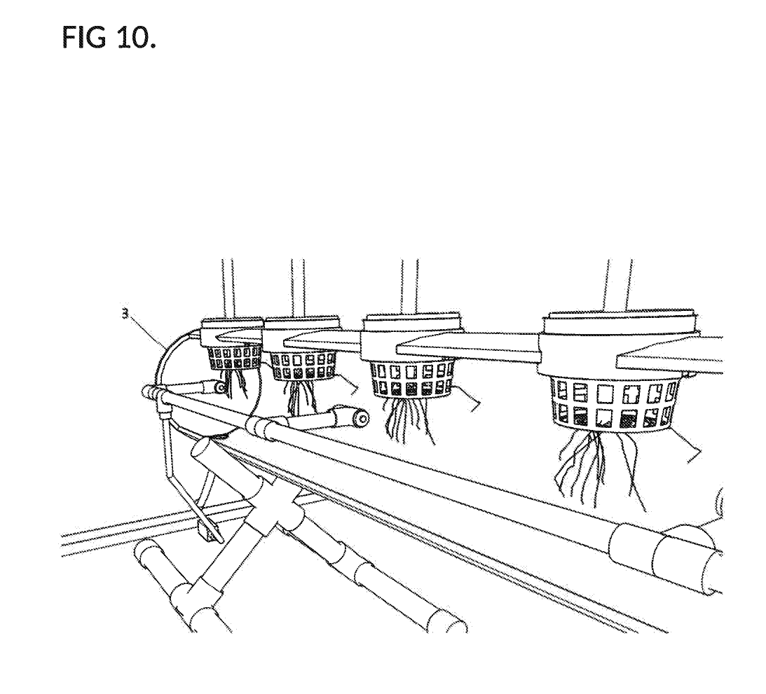

A cross-section of a growing chamber included in the first configuration (A) shown in FIG. 6 is shown in more detail in FIG. 10. As shown, plants are rooted to a cradle assembly 22 with roots hanging in the Rhizosphere 20. The absence of any growing media in the described embodiments may reduce the susceptibility of the plants to pests and/or disease.

While the disclosure has been provided and illustrated in connection with specific, presently-preferred embodiments, many variations and modifications may be made without departing from the spirit and scope of the invention(s) disclosed herein. The disclosure and invention(s) are therefore not to be limited to the exact components or details of methodology or construction set forth above. Materials for and dimensions of the various components of the described embodiments, in particular, are exemplary in nature only and may be varied or modified consistent with the disclosure. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described. The scope of the invention is to be defined solely by the appended claims, giving due consideration to the doctrine of equivalents and related doctrines.

1. A microponic irrigation system comprising:
a plurality of grow tubes, each of the plurality of grow tubes defining a grow chamber within the interior of the grow tube and comprising at least one cradle assembly to support of a plant disposed with its roots suspended in air within the grow chamber;
a pressure manifold that fluidly couples a reservoir to each of the plurality of grow tubes, the pressure manifold delivering nutrient solution housed in the reservoir to the plurality of grow tubes under pressure, wherein the pressurized nutrient solution is misted into each grow chamber to be absorbed into the roots of each rooted clone supported in the grow tube; and
a drainage manifold that collects unabsorbed nutrient solution from each of the plurality of grow tubes and circulates the unabsorbed nutrient solution back to the reservoir.

2. The microponic irrigation system of claim 1, further comprising
a tank disposed upstream of the pressure manifold in fluid communication therewith; and
a water pump disposed between the tank and the reservoir, wherein the water pump transmits nutrient solution communicated from the reservoir to the tank to be stored under pressure.

3. The microponic irrigation system of claim 1, wherein the grow tubes are elongated and disposed generally horizontally.

4. The microponic irrigation system of claim 1, wherein the grow tubes are grouped in pairs.

5. The microponic irrigation system of claim 1, wherein each of the plurality of grow tubes comprises one or more misting nozzles housed within the grow chamber and configured to emit droplets of nutrient solution not exceeding 50 micrometers (μm) in size.

6. The microponic irrigation system of claim 1, wherein the apparatus operates as a closed system which recycles nutrient solution to the water reservoir.

7. The microponic irrigation system of claim 1, wherein the plurality of cradle assemblies in each grow tube are configured to support twenty (20) plants spaced apart from one another, each plant having a maximum canopy size of 1 square foot per plant.

8. The microponic irrigation system of claim 1, wherein the plurality of cradle assemblies in each grow tube are configured to support ten (10) plants spaced apart from one another, each plant having a maximum canopy size of 2 square feet per plant.

9. A computer control system for a microponic irrigation system comprising a plurality of grow tubes that support one or more plants and a pressure manifold that fluidly communicates nutrient solution to the plurality of grow tubes under pressure, wherein the pressurized nutrient solution is misted by one or more nozzles onto the roots of each plant supported in the plurality of grow tubes, the control system comprising:
one or more processors; and
computer readable memory storing instructions that, when executed, program the one or more processors to:
control supply of the nutrient solution to the plurality of grow tubes;
monitor a pressure level of the nutrient solution in the pressure manifold; and
in response to input of command parameters received from a graphical user interface, adjust at least one of a frequency and duration of the supply of the nutrient solution to the plurality of grow tubes, while maintaining the pressure level of the nutrient solution in the pressure manifold to within a predetermined pressure range.

10. The computer control system of claim 9, further comprising:
a mobile device on which the graphical user interface is implemented; and
a server in electronic communication with the mobile device and the one or more processors, and configured to relay the command parameters inputted into the mobile device for execution by the one or more processors.
